(19) United States
(12) Patent Application Publication
(10) Pub. No.: US 2025/0256232 A1
(43) Pub. Date: Aug. 14, 2025

(54) FILTER ELEMENT WITH AN ANTI-MICROBIAL FINISH AND A FINE FILTER LAYER

(71) Applicant: Carl Freudenberg KG, Weinheim (DE)

(72) Inventors: Ulrich STAHL, Laudenbach (DE); Maria BICKEL, Heddesheim (DE); Maik SIEH, Sandhausen (DE); Volker BRAEUNLING, Heppenheim (DE)

(21) Appl. No.: 18/438,531

(22) Filed: Feb. 12, 2024

(30) Foreign Application Priority Data
Feb. 17, 2023 (DE) 10 2023 103 969.5

(51) Int. Cl. B01D 46/00; B01D 46/52; B01D 46/54; B01D 53/04

(52) U.S. Cl. CPC B01D 46/0028; B01D 46/0036; B01D 46/521; B01D 46/543; B01D 53/04; B01D 2253/102; B01D 2259/4575; B01D 2275/10; B01D 2279/35; B01D 2279/65

(57) ABSTRACT

A filter element for air filtration in a ventilation system of a mobile device, in particular of a vehicle, ship or aircraft, the filter element including a multiple-layer filter medium, the multiple-layer filter medium including an inflow-side first filter layer which is configured as a prefilter layer with an anti-microbial finish, a second filter layer which is configured as a fine filter layer, and a third filter layer which is configured as a support layer of the fine filter layer.

### CROSS-REFERENCE TO PRIOR APPLICATION

This application claims benefit to German Patent Application No. DE 102023103969.5, filed on Feb. 17, 2023, which is hereby incorporated by reference herein.

### FIELD

The invention relates to a filter element.

### BACKGROUND

Filters for the filtration of fluids, in particular of air, are known from the prior art. To this end, the filter elements are usually inserted into filter housings and are flowed through by air. Filter elements with a filter medium or filter web which is folded in a zigzag-shaped manner, in particular made from nonwoven, are produced for a very wide variety of applications. For example, they are used to filter fresh air for the interior compartment of a motor vehicle, but also in systems for air conditioning spaces. In motor vehicles, filter elements of this type are inserted into corresponding receiving devices such as, for example, filter frames and/or filter housings. Filters with very high efficiency filter media which mechanically separate particles are known. Microbial substances can also be mechanically separated. They remain in a living or endotoxic state on the filter, however, and are not denatured, which results during the course of the utilization duration of the filter in a high germ load, odor load and/or health load for the interior compartment. Moreover, there is a risk of contamination during handling of the “used” filters, which can lead to skin contact with germs and possibly allergic reaction. Filters with an anti-microbial finish are also known.

DE 10 2013 021 071 A1 describes a filter medium, in particular for filtering air for the interior compartment of motor vehicles, comprising an anti-microbial and an anti-allergenic substance. The anti-microbial substance is selected from a multiplicity of different compounds, such as metals and metal compounds, etc. The filter medium is to be capable of killing micro-organisms, in particular fungi and fungal spores, and at the same time effectively preventing bacteria, fungi and other micro-organisms growing on the filter medium.

U.S. Pat. No. 5,888,527 describes an anti-fungal, anti-bacterial and anti-viral filter which comprises a dust-collecting filter nonwoven with a finish made from a tea extract. This filter is to be suitable for binding and inactivating viruses and preventing the renewed spread of them.

WO 2014/019660 A1 describes an anti-allergenic filter for the ventilation system for the interior compartment of motor vehicles. Here, the filter substrate is finished with a polyphenol from the class of tannins as anti-bacterial medium. The filter substrate can additionally contain zinc oxide as an anti-bacterial medium.

According to the prior art, the functional layer is produced by functional substances being applied, for example by way of impregnating, coating, padding or dipping of filter layers.

It is a disadvantage in all known types of filters that there is a germ load and a risk of contamination in the case of very high efficiency filters. It has been shown that the pure separation of microbial constituent parts from the air in a very high efficiency filter does not lead to completely and lastingly pollutant-free air in the interior component, since the separated germs can “grow through” the filter medium, due to biological decomposition processes in the filter medium which are facilitated by climatic ambient conditions (namely temperature and humidity). The risk of odor formation is likewise facilitated.

It is a disadvantage of standard filters (for example, PM 2.5 filters) with an anti-microbial finish that they still allow through a significant proportion of particles and microbes, and the filter action does not meet high demands.

SUMMARY

In an embodiment, the present disclosure provides a filter element for air filtration in a ventilation system of a mobile device, in particular of a vehicle, ship or aircraft, the filter element comprising a multiple-layer filter medium, the multiple-layer filter medium including an inflow-side first filter layer which is configured as a prefilter layer with an anti-microbial finish, a second filter layer which is configured as a fine filter layer, and a third filter layer which is configured as a support layer of the fine filter layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a filter medium with a functional layer and two nonwoven layers;

FIG. 2 shows a detail of a filter element with a pleated filter medium; and

FIG. 3 shows a filter element with a pleated filter medium.

### DETAILED DESCRIPTION

In an embodiment, the present invention provides a filter element which enables very high separation and at the same time complete denaturation of all airborne particles, microbes and further substances, and complete denaturation of contaminations which are already present on the filter element. A filter element with a compact construction is also provided.

According to an embodiment of the invention, it has been recognized to be advantageous to combine a filter layer with an anti-microbial finish and a fine filter layer with one another in a filter element. Only the combination of a fine filter layer and an anti-microbial finish leads to the desired result of approximately germ-free and odor-free pure air.

The filter element according to an embodiment of the invention has a multiple-layer filter medium and serves for air filtration in a ventilation system of a stationary device, in particular of a room air cleaner, or of a mobile device, in particular of a vehicle, ship or aircraft. According to an embodiment of the invention, the multiple-layer filter medium has an inflow-side first filter layer which is configured as a prefilter layer with an anti-microbial finish, a second filter layer which is configured as a fine filter layer, and a third filter layer which is configured as support layer of the fine filter layer.

The anti-microbial finish contains anti-bacterial and/or anti-viral and/or anti-allergenic and/or anti-fungal or fungicidal substances such as, for example, acids and metals or metal compounds which prevent the filter medium from being infested with micro-organisms such as, for example, with fungi, mold, bacteria, viruses or algae.

The compact overall design of the filter element with at the same time a maximized mechanically filtering and bio-functional surface area is decisive for the practical applications in the air filtration of feed air and/or circulation of mobile devices. In this way, a sufficiently long dwell time of the air through the filter medium is achieved, with the result that the anti-microbial and biologically active substance can develop its denaturing effect on the airborne micro-organisms and also microorganisms which have already been deposited.

In an embodiment of the filter element, the first filter element can be configured as a non-woven layer of the PM 2.5 category which is suitable for pre-filtration. This categorization which is used worldwide and is recognized among experts traces back to the “National Air Quality-Standard for Particulate Matter” of the US EPA (Environmental Protection Agency).

The prefilter layer can separate fibers and coarse dusts in the size range of greater than 5 μm, particularly satisfactory in the range of greater than 10 μm. The prefilter layer can be produced from synthetic fibers, such as polypropylene, polyester and others with a fiber diameter of approximately from 30 to 50 μm and a fiber spacing of 200-400 μm.

The prefilter layer can have a progressive construction. Here, progressivity relates to the gradient of the fiber diameters from the inflow side to the outflow side of the prefilter layer, in order that similar particle sizes can accumulate depending on the fiber diameter. This fiber structure brings about a decreasing porosity of the prefilter layer, and has the advantage that the dust absorption into the nonwoven layer can be maximized with only a small increase in the air resistance. As a result, the following fine filter layer is protected against excessively high dust loading, and can serve primarily for the separation of submicron airborne particles and aerosols.

This prefilter layer thus serves for the pre-separation of relatively large airborne particles and aerosols, and has denaturing properties, that is to say the prefilter layer additionally contains an anti-microbial finish, that is to say a layer or addition or impregnation with a biologically active substance, what is known as a biocide.

The other filter layers of the filter element according to an embodiment of the invention can also be configured, in particular, as nonwoven layers. Nonwoven is understood here to be, in particular, a nonwoven in accordance with the definition of DIN EN ISO 2019-08. The nonwoven can be produced by means of staple fiber, wet-laid nonwoven or spunbonded nonwoven technology.

The filter element therefore has a multiple-layer construction, in order to ensure an improved filtration performance. To this end, a plurality of filter layers are combined in series in the filter medium of the filter element. The filter layers can be a very wide variety of materials and structures, for example with activated carbon, in HEPA quality, in the form of membranes, etc.

Thus, for example, the first filter layer can be configured as a prefilter, the second filter layer can be configured as a fine filter, and a further filter layer can be configured as an adsorption filter. The prefilter and the fine filter can be configured, for example, from organic and/or inorganic nonwoven, and the adsorption filter can be configured, for example, as a filter mat with activated carbon or with an activated carbon coating. There can also be further layers in addition to the stated layers.

The layers of the filter medium can be connected to one another in different ways: loosely by being laid on to one another and subsequent pleating, or by any type of lamination by means of adhesive bonding (polymer threads, powder, M-Web, etc.), thermally (PS calendering with/without melt fiber content) or by means of ultrasonic calendering.

A maximization of the surface area of the effective filter surface area can be brought about by way of folding of the material composite, by way of what is known as pleating.

In an advantageous embodiment of the filter element, the filter medium has an outflow-side layer which is likewise configured with an anti-microbial finish. This layer can be the third filter layer, namely the support layer, or else a further layer.

The configuration of the filter element with an anti-microbial and therefore biologically active finish therefore on both sides also makes safe, harmless handling of the used filter elements during their removal and replacement possible, since the user cannot come into contact with germ-loaded substances from biological decomposition processes of separated biomass (what is known as bio-burden).

In an advantageous embodiment, the anti-microbial finish contains citric acid. This has the advantage that the selected functional finish is harmless with respect to skin and eye irritations. Furthermore, it is connected fixedly to the first filter layer and is not volatile. Citric acid is classified as “low-risk substance” for biocidal finishing by the ECHA (European Chemicals Agency).

The anti-microbial finish of the first layer of the filter element can contain, in particular, relatively active anti-allergenic substances. Anti-allergenic substances serve, for example, to modify extremely fine pollen particles and other allergens which cannot be retained completely by the nonwoven layers of the filter medium, in such a way that they are harmless for the human immune system.

The anti-allergenic substances are present, in particular, in a concentration of 2-250 g/m², particularly preferably in a concentration of 20-25 g/m² in the case of the use of citric acid. This ensures a satisfactory anti-allergenic effect of the filter medium.

In accordance with a first variant, the anti-allergenic substances of the filter element can contain polyphenols such as catechins, flavonoids, tannins such as, for example, tannic acid. In another design variant, the anti-allergenic substances of the filter medium can contain fruit acids such as, for example, citric acid. In an embodiment, the anti-microbial finish of the first layer of the filter element can also have metals, metal compounds and/or metal oxides, in particular with aluminum, zinc, copper or silver.

The fine filter layer which also be called an aerosol filter can preferably be configured from very high efficiency filter material up to E12 or from H13 (in accordance with EN 1822). It has been recognized as being particularly advantageous for the fine filter layer to be configured with very fine filter material as HEPA material, that is to say has a high efficiency particulate air filter. A HEPA filter material of filter group H in accordance with EN 1822, 2009 edition is then used as very fine filter material.

The HEPA filter material has, in particular, a material-dependent pressure difference of from 60 to 380 Pa (Pascal) at an inflow or throughflow velocity of the fluid flow of 5.3 cm/s. The velocity of 5.3 cm/s is an industry standard for the comparison of corresponding filter materials.

The fine filter layer can also have a porous membrane.

In an embodiment of the filter element according to the invention, the fine filter layer has at least one layer consisting of microfibers and/or nanofibers. Here, the nanofibers can have, in particular, a mean diameter of from 100 to 300 nm. The advantage of nanofibers in comparison with thicker fibers is that they have a greater specific surface area and therefore make an improved filtration performance and a longer filter service life possible. Moreover, filter media consisting of nanofibers have a lower throughflow resistance and produce a lower pressure loss, which correlates with energy efficient operation of the filter element.

In an embodiment of the filter element according to the invention, the filter medium has an adsorption layer, in particular an activated carbon layer; that is to say, it has a layer with an activated carbon component as an absorbent. A filter element of this type is called a combination filter.

In an embodiment of the filter element according to the invention, it is provided with an edge band on at least one side of its side surfaces. The side surfaces are the side surfaces of the gaiter which do not extend in the direction of the fold edges, are formed by way of the zigzag-shaped edges of the filter medium, and are therefore positioned at the ends of the fold edges. The edge bands can be attached either only to one or preferably to the two side surfaces. As an alternative, the edge bands can also be attached to the further surfaces in the region of the end folds.

An edge band of this type serves firstly to stabilize the gaiter. Secondly, sealing of the side surface of the gaiter with respect to an adjoining surface of a filter receptacle can be achieved by way of the edge band. Alternative terms for “edge band” are also “side strip” or “edge strip”. The edge band is a band or strip made from a flat material, for example made from nonwoven material.

In an embodiment of the filter element, a seal, in particular a peripheral seal, is attached to its outer side, in order to seal the filter element with respect to a housing which receives the filter. Here, the seal is, in particular, of single-part configuration, with the result that the filter element is encompassed by the seal.

The seal can be configured, in particular, as an injection molded element which is molded onto the filter element.

An elastomer which can be injection-molded can be used as material for the seal, in particular a TPE, or a moldable elastomer, in particular a soft PU.

An embodiment of the invention also relates to the use of a filter element as described above as an interior compartment air filter for the filtration and cleaning of the cabin feed air in a vehicle, in particular in a passenger car, a utility vehicle or a bus.

The described invention and the described advantageous embodiments of the invention are also advantageous embodiments of the invention in combination with one another, in so far as this is technically appropriate.

Reference is made to the subclaims and the description of exemplary embodiments with reference to the appended figures with regard to further advantages and embodiments of the invention which are advantageous in a structural and functional regard.

Embodiments of the invention are to be explained in even greater detail on the basis of appended figures. Elements and components which correspond to one another are provided with identical designations in the figures. An illustration which is true to scale has been dispensed with in favor of improved clarity of the figures.

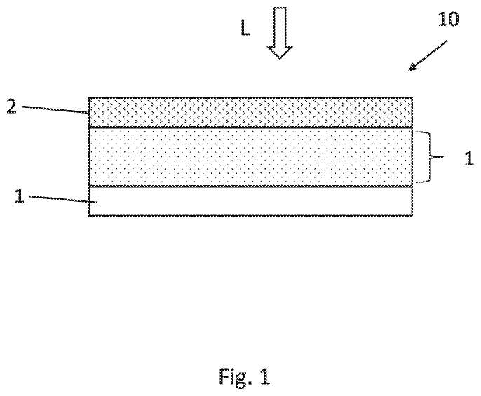

FIG. 1 shows a first embodiment of a filter medium 10 which serves for the filtration of an air flow L. The filter medium 10 has three filter layers: an inflow-side first filter layer 1 which is configured as a prefilter layer with an anti-microbial finish, a second filter layer 2 which is configured as a fine filter layer, and a third outflow-side filter layer 3 which is configured as a support layer of the fine filter layer.

The first filter layer is therefore a functional layer and contains an anti-microbial substance.

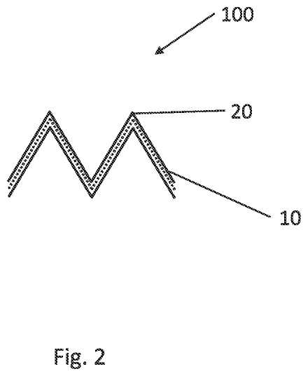

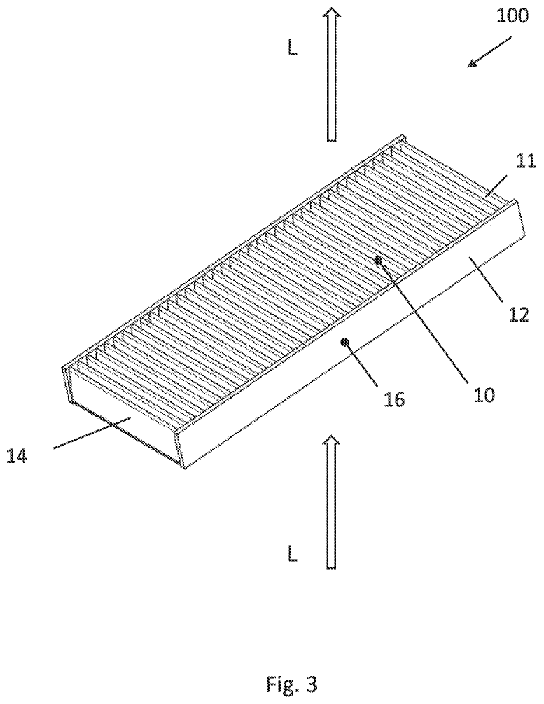

FIG. 2 shows a detail of a filter element 100. The filter medium 10 has been pleated and provided with folding edges 20, with the result that it has a greater filtration surface area. A filter element 100 of this type can additionally be provided with edge bands (see FIG. 3) and can be used in ventilation systems of mobile devices, for example in vehicles, ships or aircraft.

FIG. 3 shows a filter element 100 with a gaiter. The gaiter 11 is formed by way of a pleated filter medium 10 which is provided with folds, and has two end folds 14. The filtration surface area of the filter element 100 can be increased by way of the provision of the multiplicity of folds. On its two side surfaces 16 which do not extend in the direction of the folds, the filter 10 is provided in each case with an edge band 12. A filter element 100 of this type can be inserted into a housing. In order to clean an air flow, the latter flows through the filter medium 10 of the filter element 100 in the throughflow direction L.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF DESIGNATIONS

1 Prefilter layer with an anti-microbial finish
2 Fine filter layer
3 Support layer
10 Filter medium
11 Gaiter
12 Edge band
14 End fold
16 Side surface of the gaiter
20 Fold edge
100 Filter element
L Air flow

1. A filter element for air filtration in a ventilation system of a mobile device, in particular of a vehicle, ship or aircraft, the filter element comprising a multiple-layer filter medium, the multiple-layer filter medium including:
an inflow-side first filter layer which is configured as a prefilter layer with an anti-microbial finish,
a second filter layer which is configured as a fine filter layer, and
a third filter layer which is configured as a support layer of the fine filter layer.

2. The filter element as claimed in claim 1, wherein the first filter layer is configured as a nonwoven layer of a PM 2.5 category.

3. The filter element as claimed in claim 1, wherein the anti-microbial finish comprises anti-bacterial and/or anti-viral and/or anti-allergenic and/or fungicidal substances.

4. The filter element as claimed in claim 3, wherein the anti-microbial finish comprises a fruit acid, in particular a citric acid.

5. The filter element as claimed in claim 1, wherein the second filter layer includes a very high efficiency filter medium.

6. The filter element as claimed in claim 5, wherein the very high efficiency filter medium has nanofibers.

7. The filter element as claimed in claim 5, wherein the very high efficiency filter medium has a porous membrane.

8. The filter element as claimed in claim 1, wherein the third filter layer forms an outflow-side layer which is configured with a second anti-microbial finish.

9. The filter element as claimed in claim 1, wherein the filter medium has a further layer which forms an outflow-side layer and which is configured with a third anti-microbial finish.

10. The filter element as claimed in claim 1, wherein the filter medium has a further layer which is configured as an adsorption layer and has activated carbon.
